(19) United States
(12) Patent Application Publication
(10) Pub. No.: US 2012/0327360 A1
(43) Pub. Date: Dec. 27, 2012

(54) EYEGLASS TEMPLE STRUCTURE

(75) Inventor: Yung-Chin LIN, Chung Li City (TW)

(73) Assignee: SUNCUTE INDUSTRIES CO., LTD., Chung Li City (TW)

(21) Appl. No.: 13/486,096

(22) Filed: Jun. 1, 2012

(30) Foreign Application Priority Data
Jun. 22, 2011 (CN) 201120212849.7

(51) Int. Cl. G02C 5/22; G02C 5/14

(52) U.S. Cl. 351/121

(57) ABSTRACT

The present invention is to provide an eyeglass temple structure, which includes a temple having a plate-shaped body formed with a through hole, a temple connector being extended with a fixing ring, and a pivotal hinge structure including a cylindrical pivot body and a fastening insert. The pivot body has a middle section formed with a groove for engaging with the fixing ring, and is axially formed with an aperture. The fastening insert is engaged in the aperture and can pivot with the pivot body, so as to form the pivotal hinge structure having replaceable elements for pivotally connecting the temple to the temple connector and allowing the temple to pivot with respect to the temple connector. Thus, the pivotal hinge structure can be easily engaged with the fixing ring via the groove of the pivot body and inserted in the through hole of the temple.

### FIELD OF THE INVENTION

The present invention is to provide an eyeglass temple structure, more particularly to an eyeglass temple having a pivotal hinge with a special designed structure which is simple and easy to be used and whose elements are replaceable.

### BACKGROUND OF THE INVENTION

Eyeglasses have been a necessity in many people's daily lives. As eyeglasses vary, so do their connecting structures, the most prevalent type of which is pivotal connection. When a pair of glasses whose temples are pivotally connected to the lens frame is not in use, the temples can be rotated about their respective pivots toward the lenses so that the glasses can be carried around with ease. Nowadays, the pivotal connection of eyeglass temples is typically made by way of hinges or screws. In the eyeglass temple connection structure shown in FIGS. 1 to 3, for example, screws 1′ are used as the pivots of eyeglass temples. Frequent rotation of the temples, however, causes serious wear and tear to the screws 1′, and the screws 1′ may fall off when worn to a certain degree. Should that happen, it is unlikely to secure the temples back in place with new screws, for the screw holes must also have been worn by the screws 1′ and hence cannot engage with the new screws. Consequently, the glasses are no longer good for use and must be replaced. Moreover, the screws only serve as the pivots of the temples but do not provide a position limiting function. When the temples are rotated inward, their distal ends tend to contact with or even scratch the lenses, which is highly undesirable.

As another example, the eyeglass temple shown in FIG. 4 also uses a screw 2′ as its pivot. In addition, the temple is provided with a position-limiting block 3′ that corresponds to a groove 4′ on the lens frame. When the temple is rotated toward the lenses, the position-limiting block 3′ is engaged in the groove 4′ to produce a position limiting effect. Nevertheless, this eyeglass temple connection structure is complicated and causes difficulty in manufacture. A high production cost and a low yield rate ensue.

### BRIEF SUMMARY OF THE INVENTION

The primary object of the present invention is to provide an eyeglass temple structure which is simple and easy to use and whose connecting elements are replaceable.

Another object of the present invention is to provide an environmentally friendly eyeglass temple structure.

The technical solution to achieving the above objects consists in an eyeglass temple structure which includes a temple connector, a temple, and a pivotal hinge structure. The temple has a plate-shaped body formed with a through hole. The temple connector is extended with an annular fixing element (hereinafter also referred to as the fixing ring). The pivotal hinge structure includes a cylindrical pivot body and a fastening insert. The pivot body has a middle section formed with a groove for engaging with the fixing ring. Besides, the pivot body is axially formed with an aperture. The fastening insert is engaged in the aperture and can pivot with the pivot body so as to form the pivotal hinge structure, which pivotally connects the temple to the temple connector and allows the temple to pivot with respect to the temple connector. The pivotal hinge structure is engaged with the fixing ring of the temple connector via the groove of the pivot body and is inserted in the through hole of the temple. The plate-shaped body of the temple is kept engaged with the pivot body by the fastening insert.

Further, the two ends of the pivot body that correspond in position to the aperture are each formed, by a cutting process, with an aperture platform defined by an arc spanning more than 180°. The height of the middle section of the pivot body is less than the height of the entire cylindrical pivot body and corresponds to the width of the through hole of the temple. The fastening insert is formed as less than a semicylinder. The middle section of the fastening insert is formed with a groove corresponding in size to the aperture, while each of the two ends of the fastening insert has an outer diameter greater than the inner diameter of the aperture and less than the outer diameter of the pivot body. Moreover, the fastening insert is axially formed with a slot to increase the flexibility of the fastening insert.

Further, the two ends of the through hole of the temple are each formed with a recess corresponding to the fixing ring.

Further, the fixing ring is a circular ring with a gap, and the temple connector is provided with an outwardly curved arcuate structure adjacent to the fixing ring.

Preferably, the pivot body and the fastening insert are made of an engineering plastic or rubber.

Further, the two ends of the pivotal hinge structure are tapered structures each preferably having a degree of taper ranging approximately from 5° to 10°.

Further, the inner diameter of the fixing ring is greater than the diameter of the groove of the pivot body and is less than the maximum diameter of the two ends of the pivot body.

The present invention has the following advantageous effects. According to the present invention, the eyeglass temple is pivotally connected to and can rotate with respect to the temple connector thanks to the pivotal hinge structure. Thus, not only can screws, which are conventionally required, be dispensed with to save cost, but also the simplicity of the eyeglass temple structure allows easy assembly and disassembly, which contributes to a high yield rate. In addition, the pivotal hinge structure can be replaced when worn and thus brings about great convenience of use.

### BRIEF DESCRIPTION OF THE SEVERAL VIEWS OF THE DRAWINGS

The structure as well as a preferred mode of use, further objects, and advantages of the present invention will be best understood by referring to the following detailed description of an illustrative embodiment in conjunction with the accompanying drawings, in which:

FIG. 1 is an exploded perspective view of a conventional eyeglass temple connection structure;

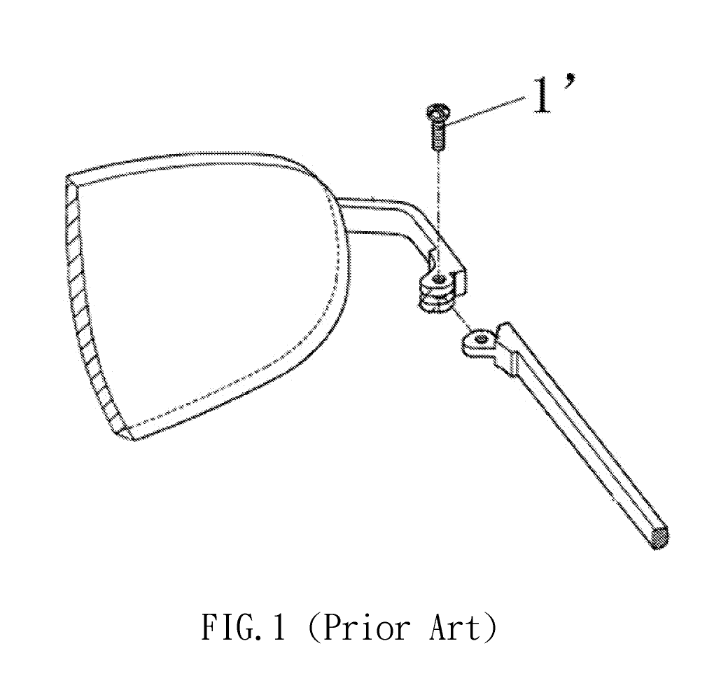

FIG. 2 is a top view of the conventional eyeglass temple connection structure of FIG. 1;

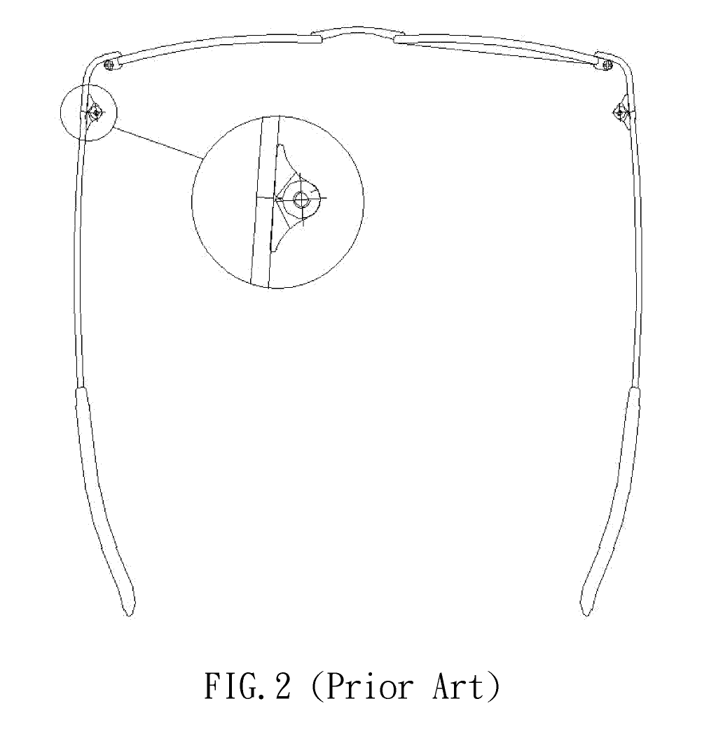

FIG. 3 is a side view of the conventional eyeglass temple connection structure of FIG. 1;

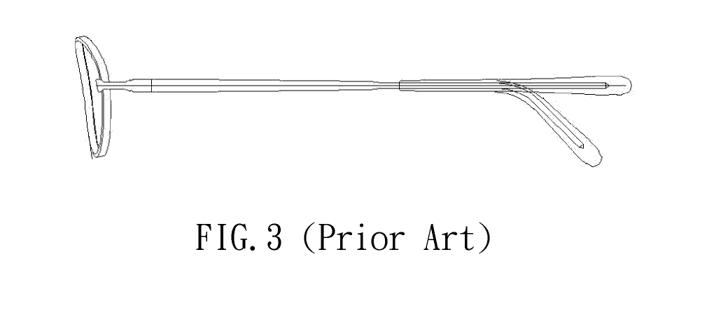

FIG. 4 is an exploded perspective view of another conventional eyeglass temple connection structure;

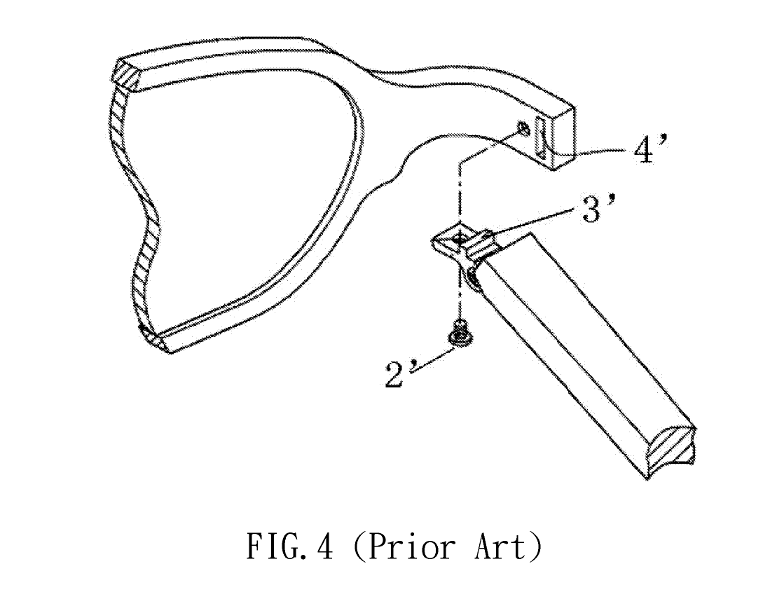

FIG. 5 is an exploded perspective view of the present invention;

FIG. 6 is an assembled perspective view of the present invention;

FIG. 7 is a perspective view of the pivot body in the present invention; and

FIG. 8 is an assembled perspective view of the pivotal hinge structure in the present invention.

### DETAILED DESCRIPTION OF THE INVENTION

The present invention is now described in more detail with reference to a preferred embodiment and the accompanying drawings.

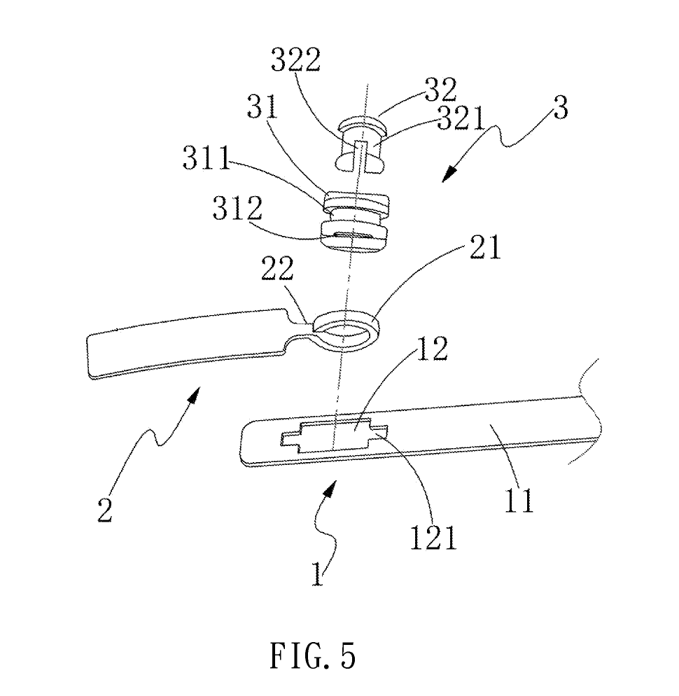

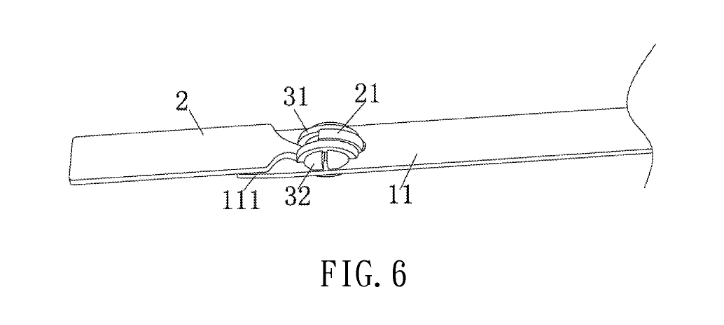

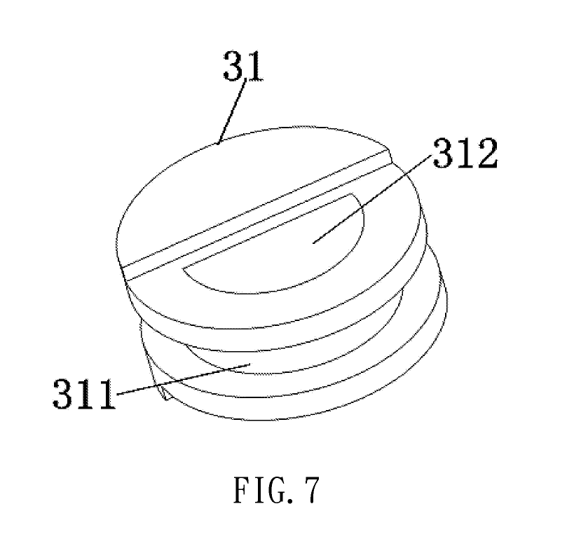

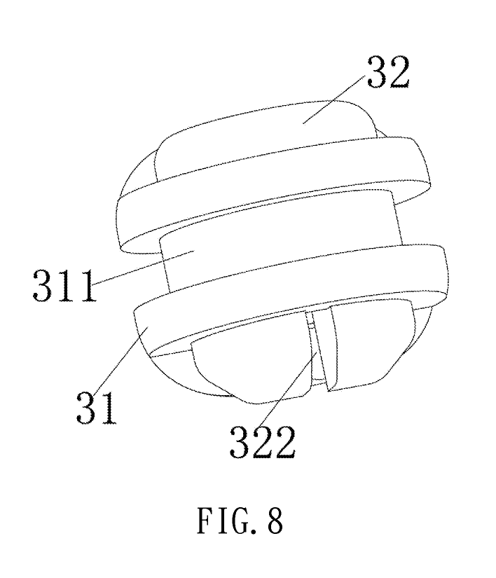

Referring to FIGS. 5 to 8, an eyeglass temple structure according to the present invention can do without the conventionally required screws and uses a pivotal hinge structure 3 instead for connecting and positioning the temple connector 2 and the temple 1. The particulars of the present invention are as follows. The temple 1 has a plate-shaped body 11 formed with a through hole 12. An annular fixing element (hereinafter also referred to as the fixing ring) 21 extends from the temple connector 2. The pivotal hinge structure 3 includes a cylindrical pivot body 31 and a fastening insert 32. The middle section of the pivot body 32 is formed with a groove 311 for engaging with the fixing ring 21. Additionally, the pivot body 31 is axially formed with an aperture 312, wherein the aperture 312 is less than a semicylinder. The two ends of the pivot body 31 that correspond in position to the aperture 312 are each cut to form an aperture platform defined by an arc spanning more than 180°. The middle section of the pivot body 31 has a height which is less than the height of the entire cylindrical pivot body 31 and which corresponds to the width of the through hole 12 of the temple 1. The fastening insert 32 is formed as less than a semicylinder and can pivot together with the pivot body 31. The middle section of the fastening insert 32 is formed with a groove 321 corresponding in size to the aperture 312. Each of the two ends of the fastening insert 32 has an outer diameter greater than the inner diameter of the aperture 312 and less than the outer diameter of the pivot body 31. The fastening insert 32 is engaged in the aperture 312, thus forming the pivotal hinge structure 3. Moreover, the fastening insert 32 is axially formed with a slot 322 to increase the flexibility of the fastening insert 32, allowing easy insertion of the fastening insert 32 into the aperture 312 of the pivot body 31 during assembly. The temple 1 is pivotally connected to and can pivot with respect to the temple connector 2 by means of the pivotal hinge structure 3. The fixing ring 21 of the temple connector 2 is a circular ring with a gap. The pivot body 31 is engaged with the fixing ring 21 via the groove 311 of the pivot body 31 and is inserted in the through hole 12 of the temple 1. The plate-shaped body 11 of the temple 1 is kept engaged with the pivot body 31 by the fastening insert 32.

The two ends of the through hole 12 of the temple 1 are each formed with a recess 121 corresponding to the fixing ring 21. Also, the temple connector 2 is provided with an outwardly curved arcuate structure 22 adjacent to the fixing ring 21. The arcuate structure 22 will not lie against the adjacent end wall of the through hole 12 once rotation of the temple 1 is stopped, for there remains a gap between the arcuate structure 22 and the through hole 12. This prevents the temple connector 2 from breaking which may otherwise result from fatigue.

The pivot body 31 and the fastening insert 32 of the pivotal hinge structure 3 can be made of an engineering plastic or rubber, so as to be lightweight, resilient, and easy to remove. The two ends of the pivotal hinge structure 3 are tapered structures to facilitate insertion of the pivotal hinge structure 3 into the fixing ring 21. Preferably, each tapered structure has a degree of taper ranging approximately from 5° to 10°. As stated above, the height of the middle section of the pivot body 31 is less than the height of the entire cylindrical pivot body 31 and corresponds to the width of the through hole 12 of the temple 1. Further, the inner diameter of the fixing ring 21 is greater than the diameter of the groove 311 of the pivot body 31 and is less than the maximum diameter of the two ends of the pivot body 31. Thus, the fixing ring 21 is engageable in the groove 311 of the pivot body 31.

The eyeglass temple structure described above is assembled in the following manner. To begin with, the pivot body 31 is inserted into the fixing ring 21 such that the fixing ring 21 is engaged in the groove 311 of the pivot body 31. Next, the fixing ring 21 and the pivot body 31 inserted therein are received in the through hole 12 of the temple 1 while the extension 111 of the plate-shaped body 11 is brought close to the temple connector 2. More particularly, the half of the pivot body 31 that is formed with the aperture 312 is passed through the through hole 12 of the temple 1 until the other half of the pivot body 31 is pressed tightly against the plate-shaped body 11 of the temple 1. After that, the fastening insert 32 is inserted into the aperture 312. Thus, the plate-shaped body 11 of the temple 1 is clamped jointly by the pivot body 31 and the fastening insert 32, and the assembly process is completed.

In use, whenever the temple 1 is pulled open, the extension 111 of the plate-shaped body 11 produces a position limiting effect. Moreover, the temple 1 is allowed smooth rotation and is less subject to wear and tear than its prior art counterparts due to that fact that the recesses 121 respectively provided at the two ends of the through hole 12 can receive the fixing ring 21 and that the temple connector 2 is provided with the arcuate structure 22 adjacent to the fixing ring 21.

While the invention herein disclosed has been described by means of specific embodiments, numerous modifications and variations could be made thereto by those skilled in the art without departing from the scope of the invention set forth in the claims.

What is claimed is:

1. An eyeglass temple structure, comprising a temple connector, a temple, and a pivotal hinge structure, the eyeglass temple structure being characterized in that: the temple has a plate-shaped body formed with a through hole; the temple connector is extended with an annular fixing element; the pivotal hinge structure comprises a cylindrical pivot body and a fastening insert, the pivot body having a middle section formed with a groove for engaging with the annular fixing element, the pivot body being axially formed with an aperture, the fastening insert being engaged in the aperture and pivotable with the pivot body so as to form the pivotal hinge structure; the temple is pivotally connected to and pivotable with respect to the temple connector via the pivotal hinge structure; the pivotal hinge structure is engaged in the annular fixing element of the temple connector via the groove of the pivot body and is inserted in the through hole of the temple; and the plate-shaped body of the temple is kept engaged with the pivot body by the fastening insert.

2. The eyeglass temple structure of claim 1, wherein: the pivot body has two ends which correspond in position to the aperture and each of which is cut to form an aperture platform defined by an arc spanning more than 180°; the middle section of the pivot body has a height which is less than a height of the entire cylindrical pivot body and which corresponds to a width of the through hole of the temple; and the fastening insert is formed as less than a semicylinder and has a middle section formed with a groove corresponding in size to the aperture, the fastening insert having two ends each having an outer diameter greater than an inner diameter of the aperture and less than an outer diameter of the pivot body.

3. The eyeglass temple structure of claim 1, wherein the fastening insert is axially formed with a slot.

4. The eyeglass temple structure of claim 1, wherein the through hole of the temple has two ends each formed with a recess corresponding to the annular fixing element.

5. The eyeglass temple structure of claim 1, wherein the annular fixing element is a circular ring with a gap.

6. The eyeglass temple structure of claim 1, wherein the temple connector is provided with an outwardly curved arcuate structure adjacent to the annular fixing element.

7. The eyeglass temple structure of claim 1, wherein the pivot body and the fastening insert are made of an engineering plastic or rubber.

8. The eyeglass temple structure of claim 1, wherein the annular fixing element has an inner diameter greater than a diameter of the groove of the pivot body and less than a maximum diameter of two ends of the pivot body.
